(19) United States
(12) Patent Application Publication
(10) Pub. No.: US 2018/0275408 A1
(43) Pub. Date: Sep. 27, 2018

(54) HEAD-MOUNTED DISPLAY APPARATUS

(71) Applicant: HTC Corporation, Taoyuan City (TW)

(72) Inventor: Qing-Long Deng, Taoyuan City (TW)

(73) Assignee: HTC Corporation, Taoyuan City (TW)

(21) Appl. No.: 15/910,008

(22) Filed: Mar. 2, 2018

Related U.S. Application Data
(60) Provisional application No. 62/470,367, filed on Mar. 13, 2017.

(51) Int. Cl. G02B 27/01

(52) U.S. Cl. CPC G02B 27/0172; G02B 27/0176; G02B 2027/013; G02B 2027/0161; G02B 2027/0112

(57) ABSTRACT

A head-mounted display apparatus is provided. The head-mounted display apparatus includes a first image-forming device and a first image beam projecting device. The first image beam projecting device is configured to project a first image beam. The first image-forming device has a first image display surface for receiving the first image beam. The first image display surface is a first curved surface. The first curved surface is bended along at least one first bending axis and at least one second bending axis, and the at least one first bending axis and the at least one second bending axis are perpendicular to each other.

### CROSS-REFERENCE TO RELATED APPLICATION

This application claims the priority benefit of U.S. provisional application Ser. No. 62/470,367, filed on Mar. 13, 2017. The entirety of the above-mentioned patent application is hereby incorporated by reference herein and made a part of specification.

### BACKGROUND OF THE INVENTION

### Field of the Invention

The invention is related to a head-mounted display apparatus, and particularly to a head-mounted display apparatus which can improve field of view.

### Description of Related Art

Typically, a head-mounted display (HMD) is designed to provide an optical lens and a display screen in front of user's eyes so that the user can enlarge the image shown on the display screen via the optical lens and thus acquiring a better watching experience. In order to provide a broader field of view (FOV), a conventional HMD is typically provided with an optical lens having high curvature. However, in the condition that the curvature of the optical lens is higher, the degree of the field curvature aberration or distortion aberration caused by the optical lens is greater. To reduce the aberration of the optical lens, the curvature of optical lens is restricted; as a result, the user's field of view is deteriorated.

Conventional techniques provide a bended display panel to overcome the above-mentioned problem. However, it is relatively difficult to manufacture such type of bended display panel and a higher manufacturing cost is required, which consequently causes the competiveness of the HMD to be reduced.

### SUMMARY OF THE INVENTION

The invention provides a head-mounted display apparatus which improves user's field of view and save manufacturing cost of the head-mounted display apparatus.

An embodiment of the invention provides a head-mounted display apparatus. The head-mounted display apparatus includes a first image-forming device and a first image beam projecting device. The first image beam projecting device is configured to project a first image beam to a first image display surface. The first image-forming device has the first image display surface configured to receive the first image beam. The first image display surface is a first curved surface. The first curved surface is bended along at least one first bending axis and at least one second bending axis, and the at least one first bending axis and the at least one second bending axis are perpendicular to each other.

In an embodiment of the invention, the first image beam projecting device includes a light source and a reflecting mirror. The light source is configured to generate the first image beam, and the reflecting mirror is configured to reflect the first image beam to the first image display surface.

In an embodiment of the invention, the first image beam projecting device further includes a microelectromechanical device and a controller. The microelectromechanical device is configured to change the rotating angle of the reflecting mirror, and the controller is configured to drive the microelectromechanical device such that the first image beam performs scanning on the first image display surface.

In an embodiment of the invention, the first image-forming device includes a plurality of sub-image-forming devices, each of the sub-image-forming devices has a sub-image display surface, and each of the sub-image display surfaces is bended along a first sub-bending axis and a second sub-bending axis perpendicular to each other.

In an embodiment of the invention, the head-mounted display apparatus further includes a first lens. The first lens is configured to receive the first image beam from the first image-forming device.

According to the above, in the embodiments of the invention, the first image-forming device of the head-mounted display apparatus has the first image display surface, and the first image display surface is in a biaxial bending state. In this manner, the head-mounted display device can provide the user with a broader field of view. Additionally, since it is not required for the first image-forming device to use a complex circuit design to display image, the manufacturing cost of the head-mounted display device may be effectively reduced.

In order to make the aforementioned features and advantages of the invention more comprehensible, embodiments accompanying figures are described in detail below.

### BRIEF DESCRIPTION OF THE DRAWINGS

FIG. 1 is a schematic view of a head-mounted display apparatus according to an embodiment of the invention.

FIG. 2A to FIG. 2D are schematic views of a first image-forming device 110 in FIG. 1 according to different embodiments of the invention.

FIG. 3A to FIG. 3B are schematic views illustrating detailed structure of the first image-forming device 110 in FIG. 1 according to different embodiments of the invention.

FIG. 4 is a schematic view of a head-mounted display apparatus according to another embodiment of the invention.

FIG. 5 is a schematic view of a first image-forming device and a second image-forming device in FIG. 4 according to an embodiment of the invention.

### DESCRIPTION OF EMBODIMENTS

Wherever appropriate in the drawings and embodiments, elements/components with the same reference numerals represent the same or similar parts. Elements/components with the same reference numerals or names in different embodiments may be cross-referenced.

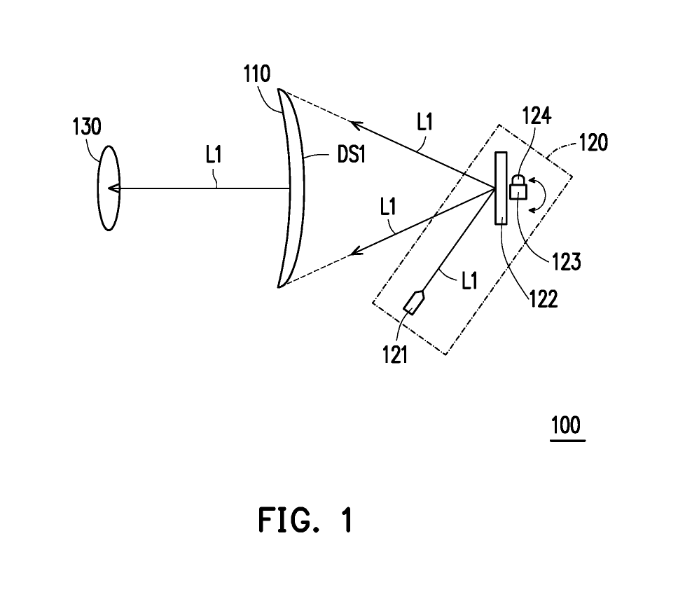

FIG. 1 is a schematic view of a head-mounted display apparatus according to an embodiment of the invention. As shown in FIG. 1, a head-mounted display apparatus 100 includes a first image-foiling device 110, a first image beam projecting device 120 and a first lens 130. The first image-forming device 100 has a first image display surface DS1, and the first image display surface DS1 is a curved surface. For example, the first image display surface DS1 may be bended along two bending axes perpendicular to each other and shown in a biaxial bending state, or the first image display surface DS1 may be bended along a plurality sets of bending axes perpendicular to each other and shown in a plurality of biaxial bending states. In this manner, the head-mounted display apparatus 100 may provide the user with a broader field of view.

The first image beam projecting device 120 may project the first image beam L1 to the first image display surface DSI such that a displayed image is generated on the first image display surface DSI. The user may receive the first image beam L1 from the first image-forming device 110 via the first lens 130 and watch the displayed image mentioned above. For example, the first image-forming device 110 may be a transparent device. In this manner, with the first lens 130, the user can watch the displayed image formed on the first image-forming device 110.

Meanwhile, the head-mounted display apparatus 100 in the embodiment may be applied to virtual reality system, augmented reality system and/or mixed reality system.

Further referring to FIG. 1, the first image beam projecting device 120 includes a light source 121, a reflecting mirror 122, a microelectromechanical device 123 and a controller 124. Depending on the need of design, the light source 121 may be a laser light source or a light emitting diode light source. The light source 121 may generate the first image beam L1, and the reflecting mirror 122 may reflect the first image beam L1 to the first image display surface DS1. The microelectromechanical device 123 is, for example, a micro actuator manufactured by using a microelectromechanical system (MEMS), which can drive the reflecting mirror 122 to rotate to change the rotating angle of the reflecting mirror 122. The controller 124 is configured to drive the microelectromechanical device 123. Since the reflecting mirror 122, the microelectromechanical device 123 and the controller 124 may form a microelectromechanical scanning device, the first image beam L1 projected by the light source 121 may perform scanning on the first image display surface DS1 and generate the displayed image on the first image display surface DS1.

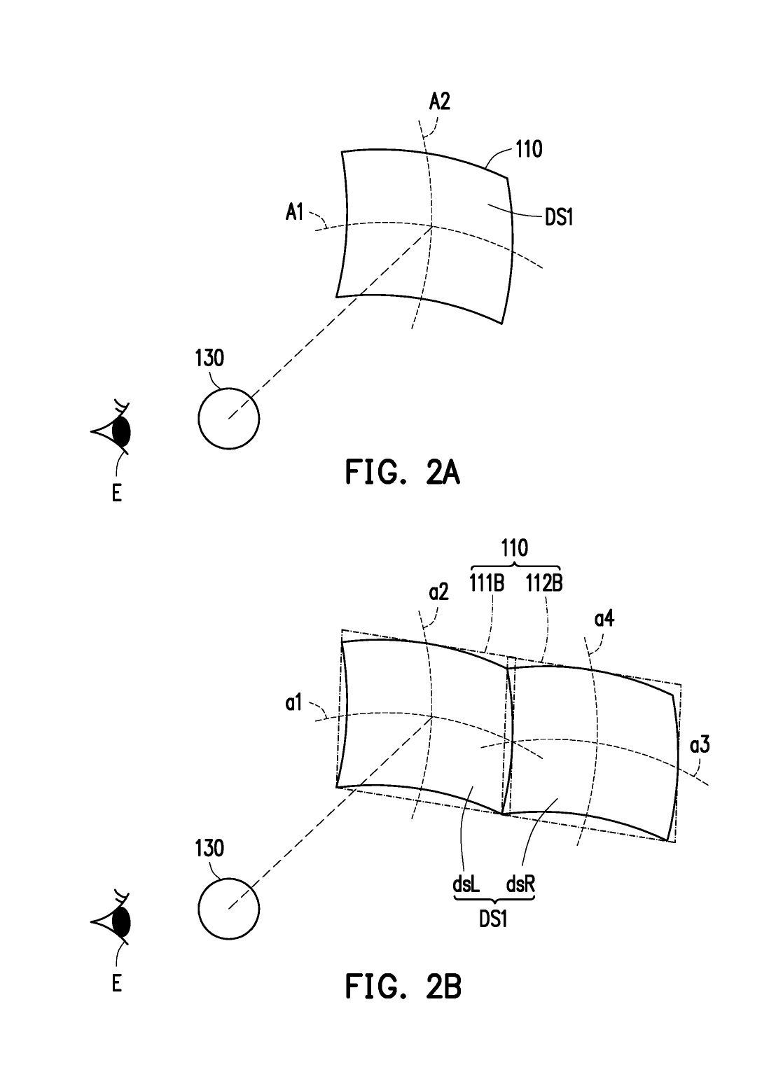

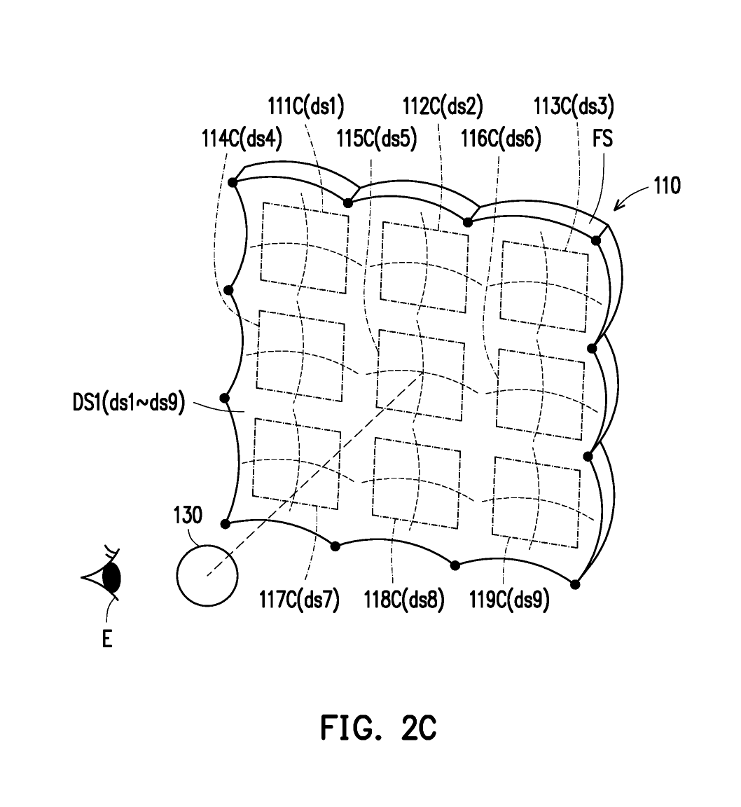

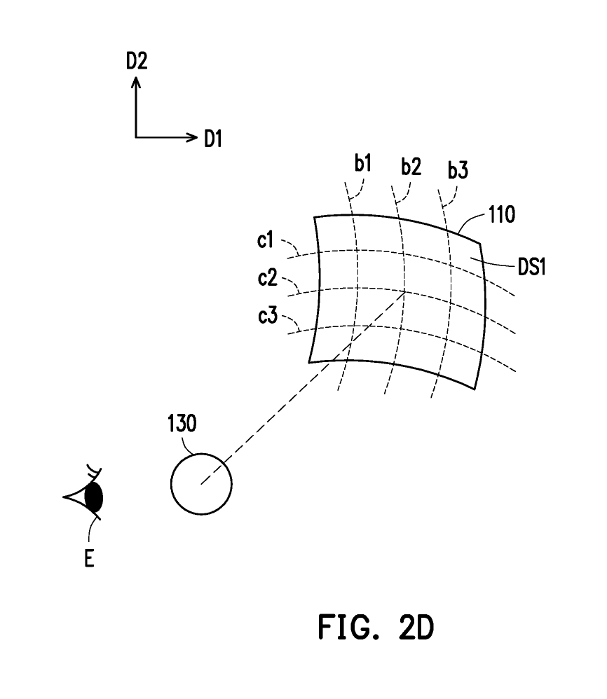

FIG. 2A to FIG. 2D are schematic views of a first image-forming device 110 in FIG. 1 according to different embodiments of the invention. As shown in FIG. 2A, the first image display surface DS1 of the first image-forming device 110 may be bended simultaneously along a first bending axis A1 (e.g., horizontal axis) and a second bending axis A2 (e.g., vertical axis) perpendicular to each other to form a curved surface with biaxial bending. In this manner, the first image display surface DS1 may simultaneously have a traverse curved surface formed along the first bending axis A1 and a longitudinal curved surface formed along the second curved axis A2. The first lens 130 may be disposed between one of the user's eyes E (e.g., left eye or right eye) and the first image display surface DS1 to enlarge the displayed image on the first image display surface DS1. In the embodiment shown in FIG. 2A, the first image-forming device 110 of the head-mounted display device 100 has the first image display surface DS1 with biaxial bending, and thus the head-mounted display devices 100 in the embodiment may provide the user with a broader field of view as compared with the image display surface having a planar shape.

In another embodiment, the first image-forming device 110 may include a plurality of sub-image-forming devices. For example, in FIG. 2B, the first image-forming device 110 includes two sub-image-forming devices 111B and 112B, and the sub-image-forming devices 111B and 112B respectively have bending image display surfaces dsL and dsR, wherein the sub-image display surface dsL is bended along a sub-bending axis a1 and sub-bending axis a2 perpendicular to each other, and the sub-image display surface dsR is bended along a sub-bending axis a3 and a sub-bending axis a4 perpendicular to each other. Since the sub-image display surfaces dsL and dsR construct the first image display surface DS1 together, and thus the first image display surface DS1 in FIG. 2B forms two curved surfaces with biaxial bending.

In the embodiment of FIG. 2B, the sub-bending axis a1 and sub-bending axis a3 may be different axes, and the sub-bending axis a2 and the sub-bending axis a4 may be different axes. For example, the sub-bending axis a1 and the sub-bending axis a3 may be parallel or unparallel with each other. The sub-bending axis a1 and the sub-bending axis a3 may be arranged along a direction of the first bending axis A1 shown in FIG. 2A but not necessarily parallel with a first bending axis A1. The sub-bending axis a2 and the sub-bending axis a4 may be parallel with unparallel with each other. The sub-bending axis a2 and the sub-bending axis a4 may be arranged along a direction of a second bending axis A2 shown in FIG. 2A but not necessarily parallel with the first bending axis A2.

In FIG. 2C, the first image-forming device 110 includes a plurality of sub-image-forming devices 111C-119C (e.g., nine of them), and the sub-image forming devices 111C-119C may be arranged in arrays. As shown in FIG. 2C, the sub-image-forming devices 111C-119C respectively have curved sub-image display surfaces ds1-ds9, and the sub-image display surfaces ds1-ds9 are respectively bended along two sub-bending axes perpendicular to each other (as indicated in dashed line). Since the sub-image display surfaces ds1-ds9 construct the first image display surface DS1 together, the first image display surface DS1 in FIG. 2C forms nine curved surfaces with biaxial bending. Additionally, in the embodiment of FIG. 2C, the first image-forming device 110 may further include a free-degree surface FS adjacent to the first image display surface DS1. For example, the contour of the first image-forming device 110 may be designed to be a free-degree surface FS to satisfy different application requirement.

Certainly, in other embodiments of the invention, the number of the sub-image-forming device may be adjusted depending on the need rather than being fixed as nine. Additionally, the arrangement of the sub-image-forming device may not be necessarily a matrix arranged neatly. The designer may design the arrangement of the sub-image-forming device according to the shape and size of the head-mounted display apparatus 100 and the invention provides no limitation thereto.

FIG. 2D is a schematic view of the first image-forming device 110 in FIG. 1 according to another embodiment of the invention. As shown in FIG. 2D, the first image display surface DS1 of the first image-forming device 110 may be bended along a plurality of bending axes b1-b3 in sequence along a first direction D1 (e.g., horizontal direction). In the meantime, the first image display surface DS1 may further be bended along a plurality of bending axes c1-c3 in sequence along a second direction D2 (e.g., vertical direction), wherein the bending axes b1-b3 along the first direction D1 and the bending axes cl-c3 along the second direction D2 are perpendicular to each other.

It should be indicated that first image display surface DS1 may be bended at different angle or the same angle according to each of the bending axes c1-c3 and bending axes b1-b3 such that the first image display surface DS1 has more adjustability.

In the embodiment of FIG. 2D, there may be an identical or different gap between two adjacent bending axes disposed along the same direction. For example, the gap between the bending axis b1 and the bending axis b2 may be different from the gap between the bending axis b2 and the bending axis b3. Likewise, the gap between the bending axis c1 and the bending axis c2 may be different from the gap between the bending axis c2 and the bending axis c3. In this manner, the curved surface with biaxial bending formed by the first image display surface DS1 in FIG. 2D may be bended at different angles according to different corresponding bending axis. In this manner, the user may feel a broader field of view when watching the displayed image on the first image display surface DS1 through the first lens 130.

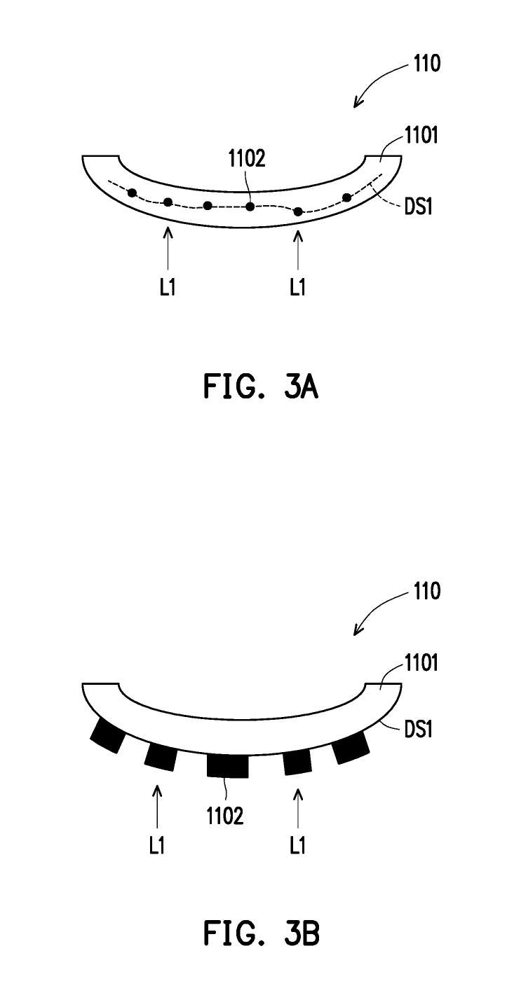

FIG. 3A to FIG. 3B are schematic views illustrating detailed structure of the first image-forming device 110 in FIG. 1 according to different embodiments of the invention. As shown in FIG. 3A to FIG. 3B, the first image-forming device 110 includes a transparent substrate 1101 and an image-forming medium 1102, and the transparent substrate 1101 is in a bending state. The interior of the transparent substrate 1101 or the surface of the transparent substrate 1101 may be provided with the image-forming medium 1102 such that the interior or the surface of the transparent substrate 1101 is formed with the first image display surface DS1 for forming an image. Since the first image-forming device 110 has light-transmissivity, after the first image beam L1 forms the displayed image on the first image display surface DS1, the first image beam L1 further passes through the first image-forming device 110 to be received by the first lens 130 in FIG. 1.

The image-forming medium 1102 may be a plurality of diffuse particles, a micro lens array, a polymer-dispersed liquid crystal (PDLC), a plurality of texture structures, a plurality of holographic grating structures or a coating layer. For example, as shown in FIG. 3A, when the image-forming medium 1102 is the diffuse particle in the transparent substrate 1101, the first image-forming device 110 may serve as a light-diffusing sheet. As shown in FIG. 3B, when the image-forming medium 1102 is the holographic grating on the surface of the transparent substrate 1101, the first image-forming device 110 may serve as a hologram. Additionally, the material of the transparent substrate 1101 may be glass, polymethyl methacrylate (PMMA) or polycarbonate (PC), the embodiment of the invention provides no limitation thereto.

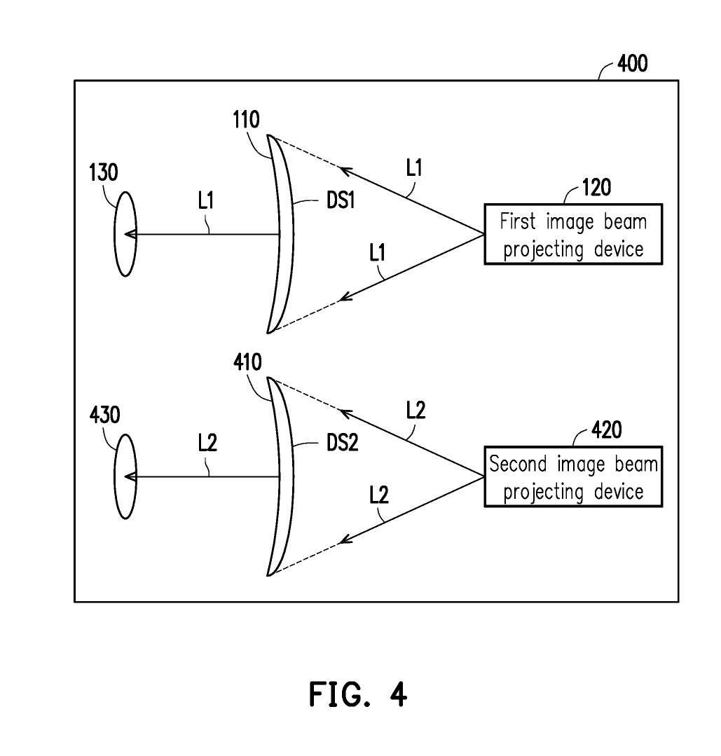

FIG. 4 is a schematic view of a head-mounted display apparatus according to another embodiment of the invention. As shown in FIG. 4, the difference between a head-mounted display apparatus 400 in FIG. 4 and the head-mounted display apparatus 100 in FIG. 1 is that the head-mounted display apparatus 400 further includes a second image-forming device 410, a second image beam projecting device 420 and a second lens 430. The second image-forming device 410 has a second image display surface DS2, and the second image display surface DS2 is a curved surface. The second image beam projecting device 420 may project the second image beam L2 to the second image display surface DS2 such that the displayed image is generated on the second image display surface DS2. The user may receive the second image beam L2 from the second image-forming device 410 via the second lens 430 and watch the displayed image.

In the embodiment of FIG. 4, the first image-forming device 110 and the second image-forming device 410 have the same structure (e.g., both are formed of transparent material), and the first image beam projecting device 120 and the second image beam projecting device 420 have the same structure (e.g., both are provided with microelectromechanical scanning device). Accordingly, the embodiments related to the first image-forming device 110 and the first image beam projecting device 120 may serve as reference for the details of realization of the second image-forming device 410 and the second image beam projecting device 420, and no repetitions are incorporated herein.

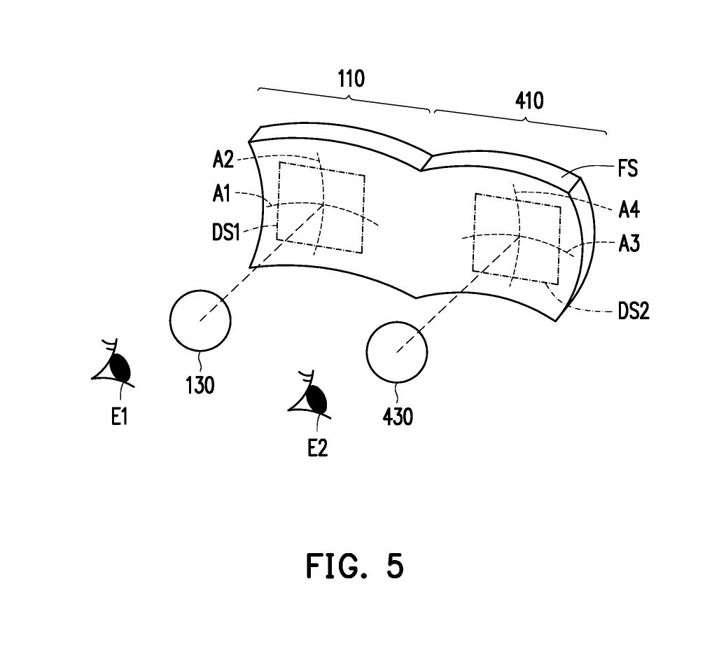

Additionally, the first image-forming device 110 and the second image-forming device 410 in FIG. 4 may be two independent image-forming devices or an image-forming device formed integrally. For example, FIG. 5 is a schematic view of the first image-forming device 110 and the second image-forming device 410 in FIG. 4 according to an embodiment of the invention. As shown in FIG. 5, the first image-forming device 110 and the second image-forming device 410 may be physically in contact with each other, and the contour of the first image-forming device 110 and the second image-forming device 410 may be designed to have a free-degree surface FS. The first image-forming device 110 has a curved first image display surface DS1, and the first image display surface DS1 is bended along the first bending axis A 1 and the second bending axis A2 perpendicular to each other. The second image-forming device 410 has a curved second image display surface DS2, and the second image display surface DS2 is bended along a third bending axis A3 and a fourth bending axis A4 perpendicular to each other. The first bending axis A1 and the third bending axis A3 may be parallel or unparallel with each other, and the second bending axis A2 and the fourth bending axis A4 may be parallel or unparallel with each other.

Additionally, in FIG. 5, the configuration position of the first lens 130 and the second lens 430 may respectively correspond to the position of the user's eyes. For example, when the first lens 130 is disposed in front of the left eye E1, the second lens 430 is disposed in front of the right eye E2 so the user can experience a three-dimensional image effect. In the embodiment, the first lens 130 and the second lens 430 may adopt Fresnel lens to reduce the volume and weight of the head-mounted display apparatus 400, which should not be construed as a limitation to the invention. In other embodiments, the first lens 130 and the second lens 430 may be other optical lens. For example, the first lens 130 and the second lens 430 may be Gauss lens, aspherical lens, free-degree lens, liquid lens, liquid crystal lens or holographic lens.

In summary, according to the embodiments of the invention, the first image-forming device and the second image-forming device of the head-mounted display apparatus respectively have the first image display surface and the second display surface, and the first image display surface and the second image display surface are both in a curved state with biaxial bending. In this manner, the head-mounted display apparatus can provide the user with a broader field of view. Additionally, since it is not required for the first image-forming device and the second image-forming device to adopt complex circuit design to display image, the manufacturing cost of the head-mounted display apparatus can be effectively reduced. Furthermore, since the first lens and the second lens do not require high curvature design, the aberration issue caused by conventional lens with high curvature may be overcome.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. A head-mounted display apparatus, comprising:
a first image-forming device, having a first image display surface, the first image display surface configured to receive a first image beam, wherein the first image display surface is a first curved surface, the first curved surface is bended along at least one first bending axis and at least one second bending axis, and the at least one first bending axis and the at least one second bending axis are perpendicular to each other; and
a first image beam projecting device, configured to project the first image beam to the first image display surface.

2. The head-mounted display apparatus according to claim 1, wherein the first image beam projecting device comprises:
a light source, configured to generate the first image beam; and
a reflecting mirror, configured to reflect the first image beam to the first image display surface.

3. The head-mounted display apparatus according to claim 2, wherein the first image beam projecting device further comprises:
a microelectromechanical device, configured to change a rotating angle of the reflecting mirror; and
a controller, configured to drive the microelectromechanical device such that the first image beam performs scanning on the first image display surface.

4. The head-mounted display apparatus according to claim 1, wherein the first image-forming device further has a free-degree surface, the free-degree surface is adjacent to the first image display surface.

5. The head-mounted display apparatus according to claim 1, wherein the first image-forming device comprises a plurality of sub-image-forming devices, each of the sub-image-forming devices has a sub-image display surface, each of the sub-image display surfaces is bended along a first sub-bending axis and a second sub-bending axis perpendicular to each other.

6. The head-mounted display apparatus according to claim 1, wherein the first image-forming device comprises:
a transparent substrate, having the first image display surface; and
an image-forming medium, disposed on the first image display surface,
wherein the first image display surface is disposed in the transparent substrate or on a surface of the transparent substrate.

7. The head-mounted display apparatus according to claim 6, wherein the transparent substrate comprises glass, polymethyl methacrylate or polycarbonate.

8. The head-mounted display apparatus according to claim 6, wherein the image-forming medium comprises a plurality of diffuse particles, a micro lens array, a polymer-dispersed liquid crystal, a plurality of texture structures, a plurality of holographic grating structures or a coating layer.

9. The head-mounted display apparatus according to claim 1, wherein the head-mounted display apparatus further comprises:
a first lens, configured to receive the first image beam from the first image-forming device.

10. The head-mounted display apparatus according to claim 9, wherein the head-mounted display apparatus further comprises:
a second image-forming device, having a second image display surface, the second image display surface configured to receive a second image beam, wherein the second image display surface is a second curved surface, and the second curved surface is bended along the first bending axis and the second bending axis perpendicular to each other; and
a second image beam projecting device, configured to project the second image beam to the second image display surface.

11. The head-mounted display apparatus according to claim 10, wherein the first image-forming device and the second image-forming device are physically in contact with each other.

12. The head-mounted display apparatus according to claim 10, wherein the head-mounted display apparatus further comprises:
a second lens, configured to receive the second image beam from the second image-forming device.

13. The head-mounted display apparatus according to claim 12, wherein the first lens and the second lens comprise a Fresnel lens, a Gauss lens, an aspherical lens, a free-degree lens, a liquid lens, a liquid crystal lens or a holographic lens.
